(19) United States
(12) Patent Application Publication
(10) Pub. No.: US 2016/0016510 A1
(43) Pub. Date: Jan. 21, 2016

(54) LIGHT GUIDE FILM APPLIED AT INSTRUMENT CLUSTER

(71) Applicant: Continental Automotive Systems, Inc., Auburn Hills, MI (US)

(72) Inventor: Humberto Merchand Alvarado, Guadalajara (MX)

(21) Appl. No.: 14/334,148

(22) Filed: Jul. 17, 2014

(51) Int. Cl. B60Q 3/04; B60Q 3/00; F21V 8/00

(52) U.S. Cl. CPC B60Q 3/044; G02B 6/0073; G02B 6/0043; B60Q 3/004; G02B 6/0045

(57) ABSTRACT

An instrument cluster assembly is disclosed and includes at least one gauge. The gauge includes a dial and a light guide film disposed behind the dial. A light source is configured to illuminate the light guide film. A plurality of emitting dots on the light guide film are configured to direct light toward the dial. The emitting dots may direct light toward associated dial graphics on the dial.

### BACKGROUND

The present disclosure is related generally to instrument clusters for vehicles.

Vehicles include instrument clusters and gauges for communicating desired operating parameters such as vehicle speed, engine rpm and direction indicators. Different methods and devices are known for communicating this information. Each method and device provides not only the function of communicating operating information to a driver, but also form and contribute to the style and aesthetic appearance of a vehicle interior. Accordingly, it is desirable to develop new and unique devices and methods for communicating and representing vehicle operating information to contribute to a desired appearance.

### SUMMARY

An instrument cluster assembly is disclosed and includes at least one gauge. The gauge includes a dial and a light guide film disposed behind the dial. A light source is configured to illuminate the light guide film. A plurality of emitting dots on the light guide film are configured to direct light toward the dial.

The emitting dots may direct light toward associated dial graphics on the dial. In one example, the light guide film is ring shaped and disposed behind a ring of graphics on the dial. A plurality of side-emitting LEDs are disposed around an outer perimeter of the light guide film and configured to illuminate it.

The use of a light guide film allows for thinner and lighter instrument clusters. The flexibility of the light guide film allows for a variety of features in the cluster assembly to be illuminated.

These and other features disclosed herein can be best understood from the following specification and drawings, the following of which is a brief description.

### BRIEF DESCRIPTION OF THE DRAWINGS

FIG. 1 is a front view of an example instrument cluster assembly.

FIG. 2 is a sectional view of the example gauge.

FIG. 3 is a perspective view of the example light guide film.

FIG. 4 is a schematic view of the example illumination.

FIG. 5 is a schematic view of an alternative example illumination.

FIG. 6 is a sectional view of the second example gauge.

FIG. 7 is a perspective view of the second example light guide film.

### DETAILED DESCRIPTION

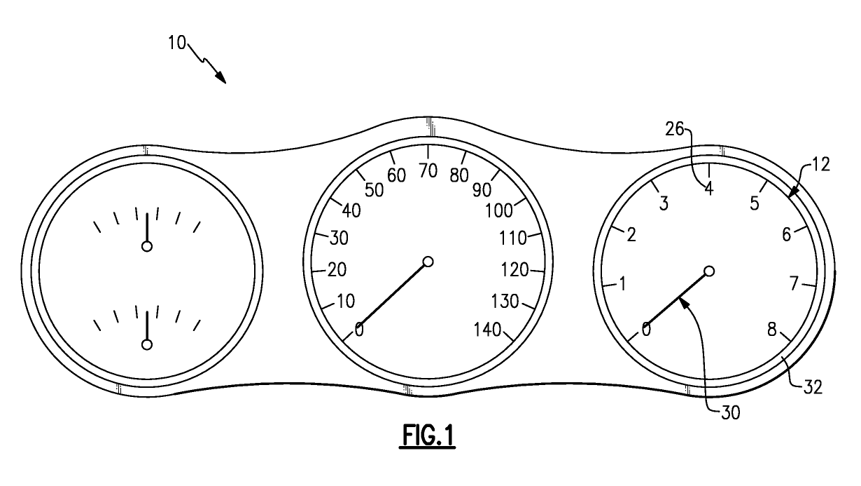

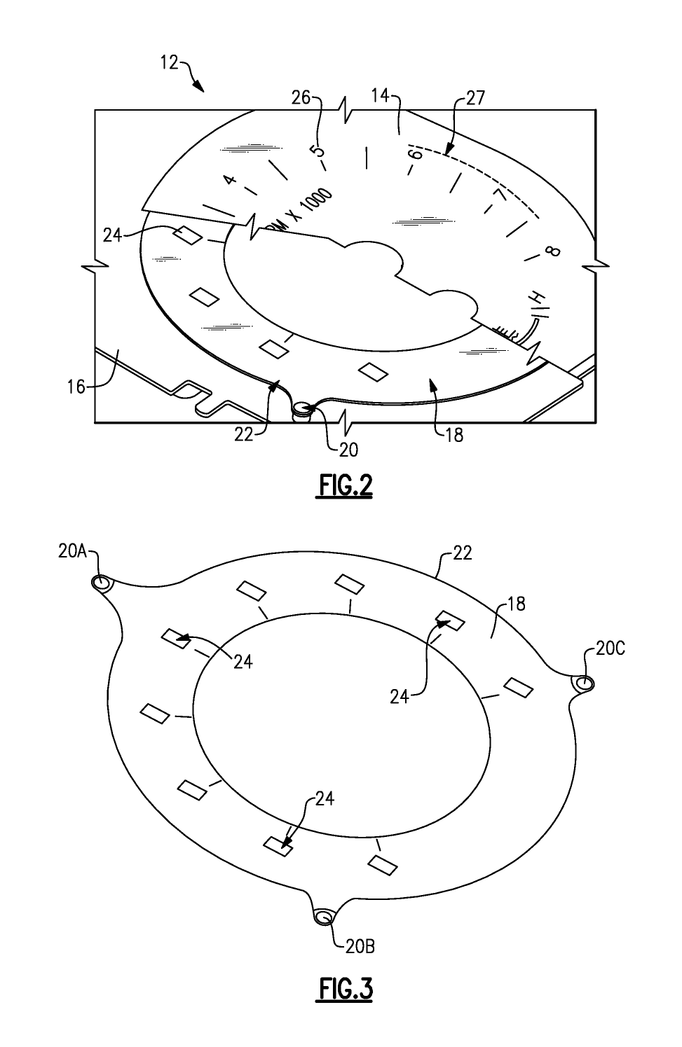

Referring to FIGS. 1 and 2, an example instrument cluster assembly 10 includes at least one gauge 12. The example gauge 12 includes a dial 14, a printed circuit board 16 disposed behind the dial 14, and a light guide film 18 disposed between the dial 14 and the printed circuit board 16.

The example gauge 12 further includes at least one light source 20 configured to illuminate the light guide film 18. The example light source 20 is a side emitting LED in communication with printed circuit board 16 and disposed radially outward of an outer perimeter 22 of the light guide film 18. Other types of light sources are also contemplated. The light source 20 is configured to emit light toward the light guide film 18 to illuminate the light guide film 18.

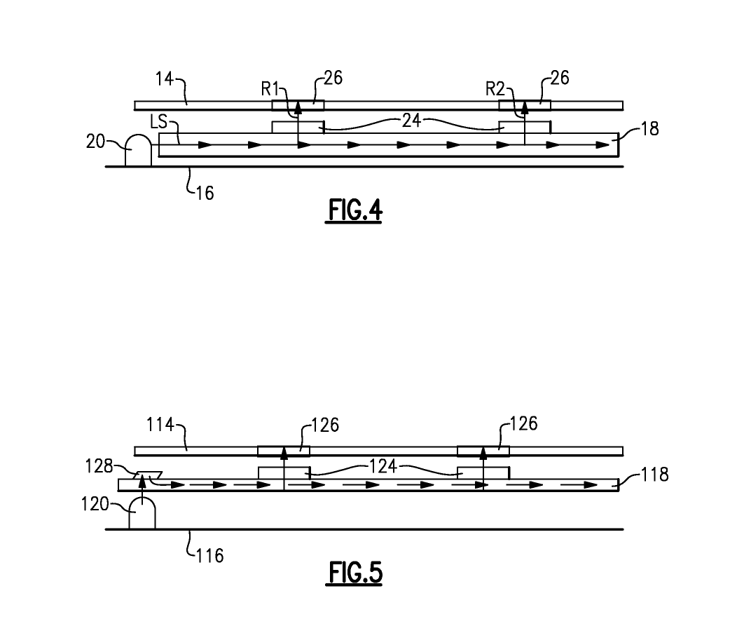

Referring to FIGS. 3 and 4 with continued reference to FIGS. 1 and 2, the light guide film 18 includes a plurality of light emitting dots 24, which are configured to direct light outward from the light guide film 18. In one application, the emitting dots 24 are laser engraved onto the film 18. The example light emitting dots 24 direct the light toward dial graphics 26 on the dial 14. The light source 20, the light guide film 18, and the emitting dots 24 thus illuminate the dial graphics 26 on the dial 14, as shown schematically in FIG. 4. The light emitted from the light source 20 throughout the light guide film 18 is represented schematically as LS. The light directed from the light guide film 18 toward the dial graphics 26 is represented schematically as R1 and R2.

In one application, the light guide film 18 is applied directly to the back of the dial 14. The light guide film 18 may also or alternatively be applied directly to the printed circuit board 16.

The example light guide film 18 is ring shaped and configured to be disposed behind the ring of dial graphics 26 on the dial 14, but other light guide film shapes and arrangements are contemplated. By using a single ring shaped light guide film 18 for one ring of dial graphics 26, fewer light sources 20 are necessary.

Each example emitting dot 24 is disposed directly behind an associated dial graphic 26 to illuminate that dial graphic 26. More than one emitting dot 24 may be associated with a single dial graphic 26, and more than one dial graphic 26 may be associated with a single emitting dot 24. Dial graphics 26 may include numbers, tick marks, lines, symbols, or anything else to be illuminated on the dial. In one application, the emitting dots 24 imitate the shapes of their associated dial graphics 26. The shapes, density, and distribution of the emitting dots 24 are easily customizable to meet the illumination needs of the particular gauge.

The example gauge utilizes three light sources 20A,B,C disposed radially outward of the outer perimeter 22 of the light guide film 18, but other numbers of light sources and arrangements are contemplated. One or more light sources 20 may be disposed radially outward of an outer perimeter 27 of the dial graphics 26. As another example, at least one light source 20 may be disposed radially inward of an inner perimeter of a ring shaped light guide film 18.

The example gauge 12 utilizes light guide film 18 to illuminate graphics 26 on the dial 14, but light guide film may be used to illuminate other features on the instrument cluster assembly 10 as well. For example, light guide film may be used to illuminate a pointer assembly 30 or an outer ring 32.

A light guide film is thin and flexible. Light guide film is thus thinner, lighter, and more flexible than current light guide designs in instrument clusters. Utilizing a light guide film in an instrument cluster would thus allow for thinner and lighter clusters, and the light guide film's flexibility creates the possibility for new features to be illuminated.

The example light guide film 18 may be made of plastic or silicone rubber. Other materials are contemplated. The example film 18 is approximately 0.2 mm, but other thicknesses (0.1 mm-1.5 mm) are contemplated. In the example, the distance between the dial 14 and the printed circuit board 16 is less than 3 millimeters, because of the low thicknesses of the light guide film 18 and the LED 20 (less than 2 millimeters), which allows for significant space saving.

The light guide film 18 has a unique property in that light is trapped inside the film (shown schematically in FIG. 4), and only emitted through the emitting dots 24. There is not much light dissipation other than that from the emitting dots 24, which may eliminate the need for a light housing. Traditional instrument cluster light guides require light housing to prevent light dissipation to unwanted areas. Because the light guide film 18 traps most light inside the film, such a light housing may not be necessary, which is another reason instrument cluster 10 can be significantly thinner than traditional clusters.

In one alternative example, shown schematically in FIG. 5, the light source 120 is a top emitting LED disposed behind the light guide film 118 and in communication with printed circuit board 116. The top emitting LED is configured to emit light toward a reflector 128 on the light guide film 118, which reflects light across the light guide film 118 to illuminate the light guide film 118. This example similarly includes emitting dots 124 on the light guide film 118 for directing light outward from the light guide film 118. The emitting dots 124 may direct light toward dial graphics 126 on the dial 114.

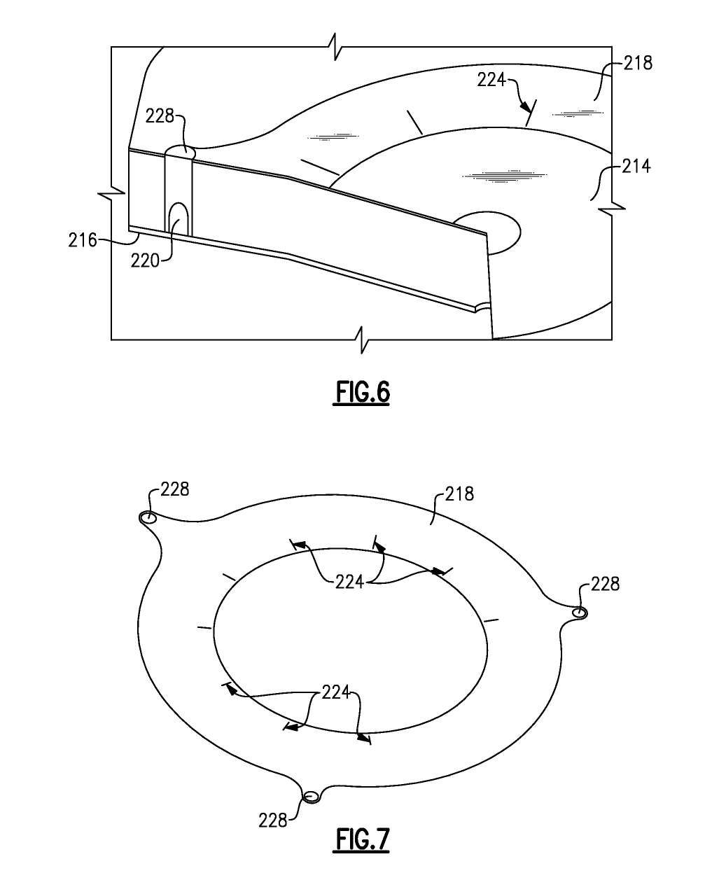

In example gauge 212, shown in FIGS. 6 and 7, the light guide film 218 is disposed on the face of the dial 214, rather than behind it. In this example, at least one top emitting LED 220 is disposed behind the dial 214 and connected to printed circuit board 216 and configured to emit light toward a reflector 228 on the light guide film 218. The reflector 228 is configured to reflect light across the light guide film 218, and emitting dots 224 (tick marks in the example) direct light outward. The light guide film 218 in the example gauge 212 is thus used as a decorative part on the face of dial 214, rather than as a backlight.

Although the different examples have a specific component shown in the illustrations, embodiments of this disclosure are not limited to those particular combinations. It is possible to use some of the components or features from one of the examples in combination with features or components from another one of the examples.

Although embodiments of this invention have been disclosed, a worker of ordinary skill in this art would recognize that certain modifications would come within the scope of this invention. For that reason, the following claims should be studied to determine the true scope and content of this invention.

We claim:

1. A gauge comprising:
a dial;
a light guide film disposed behind said dial; and
at least one light source configured to illuminate said light guide film, wherein said light guide film includes a plurality of emitting dots configured to direct light toward the dial.

2. The gauge as recited in claim 1, wherein said dial includes a plurality of dial graphics, and at least one of said plurality of emitting dots is configured to direct light toward one or more of said plurality of dial graphics.

3. The gauge as recited in claim 1, wherein said dial includes a plurality of dial graphics, and each of said plurality of emitting dots is configured to direct light toward one or more of said plurality of dial graphics.

4. The gauge as recited in claim 1, wherein said at least one light source comprises an LED.

5. The gauge as recited in claim 1, wherein said at least one light source comprises three LEDs.

6. The gauge as recited in claim 1, wherein said at least one light source comprises a side emitting LED disposed radially outward of an outer perimeter of said light guide film and configured to emit light toward said light guide film.

7. The gauge as recited in claim 1, wherein said at least one light source comprises at least three side emitting LEDs disposed radially outward of an outer perimeter of said light guide film and configured to emit light toward said light guide film.

8. The gauge as recited in claim 1, wherein said at least one light source comprises a top emitting LED configured to emit light toward a reflector disposed on said light guide film, wherein said reflector is configured to reflect light across said light guide film.

9. The gauge as recited in claim 2, wherein said light guide film is ring shaped and disposed behind a ring of said dial graphics.

10. The gauge as recited in claim 1, wherein said plurality of emitting dots is configured to direct light toward the dial to illuminate a pointer assembly.

11. The gauge as recited in claim 1, wherein said plurality of emitting dots is configured to direct light toward the dial to illuminate an outer ring of said gauge.

12. An instrument cluster assembly comprising:
a dial;
a printed circuit board disposed behind said dial;
a light guide film disposed between said dial and said printed circuit board;
at least one LED in communication with said printed circuit board and configured to illuminate said light guide film, wherein said light guide film includes a plurality of emitting dots configured to direct light toward one or more dial graphics on said dial.

13. The instrument cluster assembly as recited in claim 12, wherein said at least one light source comprises a side emitting LED disposed radially outward of an outer perimeter of said light guide film and configured to emit light toward said light guide film.

14. The instrument cluster assembly as recited in claim 12, wherein said at least one light source is disposed radially outward of an dial graphic outer perimeter of said dial graphics.

15. The instrument cluster assembly as recited in claim 12, wherein said at least one light source comprises at least three side emitting LEDs in communication with said printed circuit board and disposed radially outward of an outer perimeter of said light guide film and configured to emit light toward said light guide film.

16. The instrument cluster assembly as recited in claim 14, wherein each of said at least three side emitting LEDs is disposed radially outward of an dial graphic outer perimeter of said dial graphics.

17. The instrument cluster assembly as recited in claim 12, wherein the distance between said printed circuit board and said dial is less than one inch.

18. The instrument cluster assembly as recited in claim 12, wherein said light guide film is ring shaped and disposed behind a ring of said dial graphics.

19. A method of assembling a gauge comprising:
providing a dial;
providing a light guide film behind said dial;
mounting at least one light source configured to illuminate said light guide film, wherein said light guide film is configured to direct light toward said dial.

20. The method as recited in claim 19, further comprising:
providing light emitting dots in in discrete locations to direct light toward said dial.
